(19) United States
(12) Patent Application Publication
(10) Pub. No.: US 2026/0187235 A1
(43) Pub. Date: Jul. 2, 2026

(54) Neutralizing malicious activities against databases

(71) Applicant: DBDome Ltd., Tirat HaCarmel (IL)

(72) Inventors: Yoram Dan, Tel Aviv (IL); Tal Cohen, Tirat HaCarmel (IL)

(21) Appl. No.: 19/096,750

(22) Filed: Apr. 1, 2025

Related U.S. Application Data
(60) Provisional application No. 63/740,361, filed on Dec. 31, 2024.

(51) Int. Cl. G06F 21/55; G06F 21/62

(52) U.S. Cl. CPC G06F 21/554; G06F 21/6227; G06F 2221/034

(57) ABSTRACT

Systems, methods, and computer program products for protecting a database against malicious activity are disclosed. A computer implemented method for protecting a database includes neutralizing an identified malicious activity performed with respect to the database during the occurrence of the malicious activity. The database may include a data masking mechanism where the neutralization of the malicious activity may utilize the data masking mechanism.

### CROSS-REFERENCE TO RELATED APPLICATION

This application claims the benefit of U.S. Provisional Patent Application 63/740,361, filed Dec. 31, 2024, which is incorporated herein by reference.

### FIELD

The present disclosure relates generally to cybersecurity, and more specifically, to systems, methods and computer program products for protecting databases from cybersecurity threats by neutralizing related malicious activity.

### BACKGROUND

Database security is highly important and may include various measures designed to protect databases from malicious attacks, misuse and unauthorized access. Common threats to database security include Structured Query Language (SQL) injection, unauthorized use of sensitive data, insider threats and more.

Database attacks may lead to data theft, customers reimbursements, regulatory fines or reputational damage and may cost millions of dollars to fix. In today's rapidly evolving digital landscape, safeguarding data is more crucial than ever.

Typical responses to identified cyber-attacks may include containing and minimizing damage. For example, the Internet Protocol (IP) address of the attacker may be blacklisted or blocked, or the attacker's connections may be closed. However, such countermeasures may not prevent or stop the attacker from attacking again (e.g., promptly again), for example, by using a different IP address. In particular, such cyber-attacks may be characterized by a series or multiple attacks, e.g., via bots researching or fishing for information, which may not be stopped or deterred by the existing countermeasures.

### SUMMARY

In accordance with aspects of the present disclosure, a computer implemented method for protecting a database includes neutralizing an identified malicious activity performed with respect to the database while occurring.

In various embodiments of the method, the database includes a data masking mechanism and neutralizing the malicious activity utilizes the data masking mechanism.

In various embodiments of the method, the malicious activity is generated by a Structured Query Language (SQL) client and includes an incoming connection currently running a client SQL statement, and the method further includes altering the structure of the client SQL statement.

In various embodiments of the method, altering the structure of the client SQL statement includes replacing the client SQL statement with a crafted SQL statement.

In various embodiments of the method, the method further includes crafting the SQL statement replacing the client SQL statement.

In various embodiments of the method, the crafted SQL statement includes a pre-defined SQL statement.

In various embodiments of the method, the altering of the structure of the client SQL statement is performed such that its result would delay the operation of the SQL client.

In various embodiments of the method, altering the structure of the client SQL statement includes utilizing a function configured to pause the operation of the client SQL statement.

In various embodiments of the method, the altering of the structure of the SQL statement is performed such that its result would hold significant memory of the SQL client.

In various embodiments of the method, the altering of the structure of the client SQL statement is performed in a dynamic manner.

In various embodiments of the method, the altering of the structure of the client SQL statement is performed with respect to the client SQL statement and such that the result of the altered SQL statement is related to the client SQL statement.

In various embodiments of the method, the database includes a data masking mechanism where the altering of the structure of the client SQL statement is performed via the data masking mechanism.

In various embodiments of the method, altering the client SQL statement includes applying a data masking mechanism of the database on the client SQL statement and executing a crafted function via the data masking mechanism, where the crafted function is configured to generate data.

In various embodiments of the method, the method further includes identifying the malicious activity.

In various embodiments of the method, identifying the malicious activity includes identifying the SQL connection or identifying the SQL statement.

In various embodiments of the method, identifying the SQL connection includes capturing the source Internet Protocol (IP) address of the incoming SQL connection.

In various embodiments of the method, identifying the SQL statement includes logging and analyzing the original SQL query sent by the client.

In various embodiments of the method, the database is installed on a server, and the neutralizing of the identified malicious activity performed with respect to the database is operated via a monitoring server different from the server.

In accordance with aspects of the present disclosure, a system for protecting a database includes at least one controller and at least one computer readable storage device or medium storing instructions for execution by the at least one controller. The instructions, when executed, cause the system to neutralize an identified malicious activity performed with respect to the database while occurring.

In various embodiments of the system, the database includes a data masking mechanism and neutralizing of the malicious activity utilizes the data masking mechanism.

In various embodiments of the system, the malicious activity is generated by an SQL client and includes an incoming connection currently running a client SQL statement, where the instructions, when executed, further cause the system to alter the structure of the client SQL statement.

In various embodiments of the system, altering the structure of the client SQL statement includes replacing the client SQL statement with a crafted SQL statement.

In various embodiments of the system, the instructions, when executed, further cause the system to craft the SQL statement replacing the client SQL statement.

In various embodiments of the system, the crafted SQL statement includes a pre-defined SQL statement.

In various embodiments of the system, the altering of the structure of the client SQL statement is performed such that its result would delay the operation of the SQL client.

In various embodiments of the system, altering the structure of the client SQL statement includes utilizing a function configured to pause the operation of the client SQL statement.

In various embodiments of the system, the altering of the structure of the SQL statement is performed such that its result would hold significant memory of the SQL client.

In various embodiments of the system, the altering of the structure of the client SQL statement is performed in a dynamic manner.

In various embodiments of the system, the altering of the structure of the client SQL statement is performed with respect to the client SQL statement and such that the result of the altered SQL statement is related to the client SQL statement.

In various embodiments of the system, the database includes a data masking mechanism where the altering of the structure of the client SQL statement is performed via the data masking mechanism.

In various embodiments of the system, altering the client SQL statement includes applying a data masking mechanism of the database on the client SQL statement and executing a crafted function via the data masking mechanism, where the crafted function is configured to generate data.

In various embodiments of the system, the instructions, when executed, further cause the system to identify the malicious activity.

In various embodiments of the system, identifying of the malicious activity includes identifying the SQL connection or identifying the SQL statement.

In various embodiments of the system, identifying of the SQL connection includes capturing the IP address of the incoming SQL connection.

In various embodiments of the system, identifying the SQL statement includes logging and analyzing the original SQL query sent by the client.

In various embodiments of the system, the database is installed on a server, and the neutralizing of the identified malicious activity performed with respect to the database is operated via a monitoring server different from the server.

In accordance with aspects of the present disclosure, a computer program product includes a computer-readable storage medium having computer-executable instructions for causing the neutralization of an identified malicious activity performed with respect to a database while occurring.

In various embodiments of the computer program product, the database includes a data masking mechanism where neutralizing the malicious activity is configured to utilize the data masking mechanism.

In various embodiments of the computer program product, the malicious activity is generated by an SQL client and includes an incoming connection currently running a client SQL statement, where the instructions are configured to cause altering of the structure of the client SQL statement.

In various embodiments of the computer program product, altering the structure of the client SQL statement includes replacing the client SQL statement with a crafted SQL statement.

In various embodiments of the computer program product, the instructions are configured to cause crafting of the SQL statement replacing the client SQL statement.

In various embodiments of the computer program product, the crafted SQL statement includes a pre-defined SQL statement.

In various embodiments of the computer program product, the altering of the structure of the client SQL statement is to be performed such that its result would delay the operation of the SQL client.

In various embodiments of the computer program product, altering the structure of the client SQL statement includes utilizing a function configured to pause the operation of the client SQL statement.

In various embodiments of the computer program product, the altering of the structure of the SQL statement is to be performed such that its result would hold significant memory of the SQL client.

In various embodiments of the computer program product, the altering of the structure of the client SQL statement is to be performed in a dynamic manner.

In various embodiments of the computer program product, the altering of the structure of the client SQL statement is to be performed with respect to the client SQL statement and such that the result of the altered SQL statement is related to the client SQL statement.

In various embodiments of the computer program product, the database includes a data masking mechanism and the altering of the structure of the client SQL statement is to be performed via the data masking mechanism.

In various embodiments of the computer program product, altering the client SQL statement includes applying a data masking mechanism of the database on the client SQL statement and executing a crafted function via the data masking mechanism, where the crafted function is configured to generate data.

In various embodiments of the computer program product, the instructions are configured to cause the identification of the malicious activity.

In various embodiments of the computer program product, identification of the malicious activity includes identifying the SQL connection or identifying the SQL statement.

In various embodiments of the computer program product, identifying of the SQL connection includes capturing the source IP address of the incoming SQL connection.

In various embodiments of the computer program product, identifying of the SQL statement includes logging and analyzing the original SQL query sent by the client.

In various embodiments of the computer program product, the database is installed on a server, and the neutralizing of the identified malicious activity performed with respect to the database is configured to be operated via a monitoring server different from the server.

### BRIEF DESCRIPTION OF THE DRAWINGS

The above and other aspects and features of the disclosure will become more apparent in view of the following detailed description when taken in conjunction with the accompanying drawings wherein like reference numerals identify similar or identical elements.

FIG. 1 is a diagram of a system for protecting a database, in accordance with aspects of the disclosure;

FIG. 2 is a flow diagram of a computer implemented method for protecting databases, in accordance with aspects of the disclosure;

FIG. 3 is an illustration of an exemplary neutralization process of a malicious activity, in accordance with aspects of the disclosure;

FIG. 4 is a diagram of a further system for protecting databases, in accordance with aspects of the disclosure; and

FIG. 5 is a flow diagram of a further computer implemented method for protecting databases, in accordance with aspects of the disclosure.

It will be appreciated that for simplicity and clarity of illustration, elements shown in the figures have not necessarily been drawn to scale. For example, the dimensions and/or aspect ratio of some of the elements can be exaggerated relative to other elements for clarity. Further, where considered appropriate, reference numerals can be repeated among the figures to indicate corresponding or analogous elements throughout the serial views.

### DETAILED DESCRIPTION

The present disclosure relates to systems, methods and computer program products for neutralizing cybersecurity threats or attacks. The present disclosure provides proactive protection by actively neutralizing threats before they can impact a customer's business operations. The present disclosure introduces a unique model that complements the four classical pillars of cybersecurity (Prevent, Detect, Respond, Recover) by adding a critical layer of deterrence.

The disclosed systems, methods and computer program products may neutralize an attack by generating a situation in which an identified connection (e.g., a new connection) is not responding or by making the attacker's connection or the database querying or interrogation non-useful, obsolete or even annoying for the attacker, thereby deterring the attacker from reattacking.

In the following detailed description, specific details are set forth in order to provide a thorough understanding of the disclosure. However, it will be understood by those skilled in the art that the disclosure may be practiced without these specific details. In other instances, well-known methods, procedures, and components have not been described in detail so as not to obscure the present disclosure. Some features or elements described with respect to one system may be combined with features or elements described with respect to other systems. For the sake of clarity, discussion of same or similar features or elements may not be repeated.

Although the disclosure is not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like. Although the disclosure is not limited in this regard, by using the term “or” when listing two or more items or options, it is meant that each item, and each plausible or feasible combination of the listed items including a combination of all listed items may be considered.

Unless explicitly stated, the methods described herein are not constrained to a particular order or sequence. Additionally, some of the described methods or elements thereof can occur or be performed simultaneously, at the same point in time, or concurrently.

The term “server”, as referred to herein, may relate to a physical server or to a virtual server.

The term “SQL statement”, as referred to herein, is a database related transaction which may generate operations to be applied to a database including inserting, updating, deleting or selecting data.

The term “query”, as referred to herein, is a type of an SQL statement which may generate operations to be applied to a database including data selection.

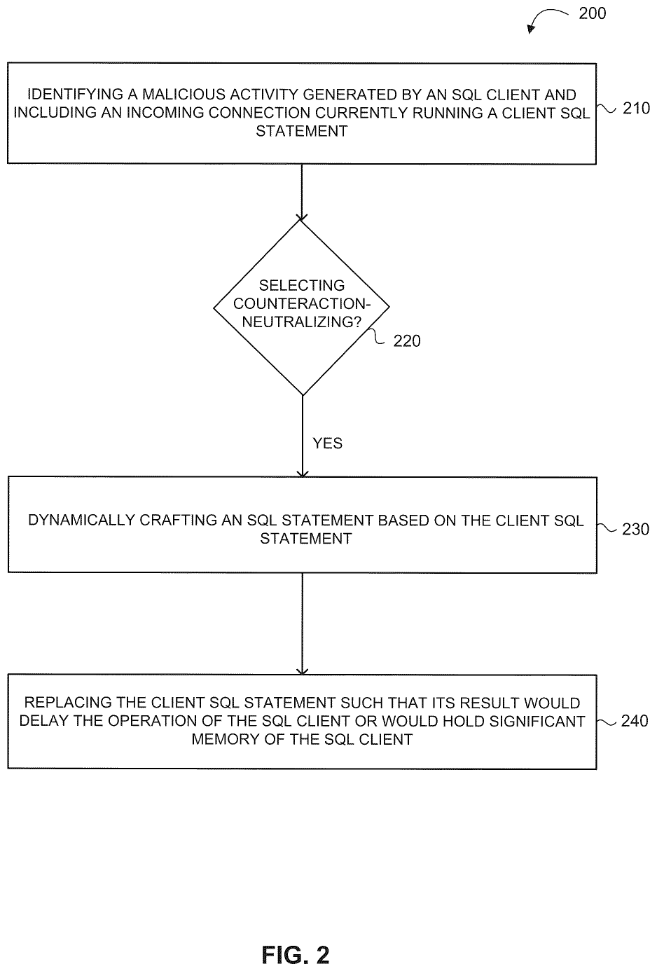

A system for protecting one or more databases installed on one or more servers from security threats or malicious activities is disclosed. The system may include at least one controller and at least one computer readable storage device storing instructions for execution by the at least one controller. The instructions, when executed, may cause the system to neutralize an identified malicious activity performed with respect to a database while occurring. According to some aspects, the instructions, when executed, may cause the system to apply the disclosed methods, including method 200 of FIG. 2, as will be detailed herein below.

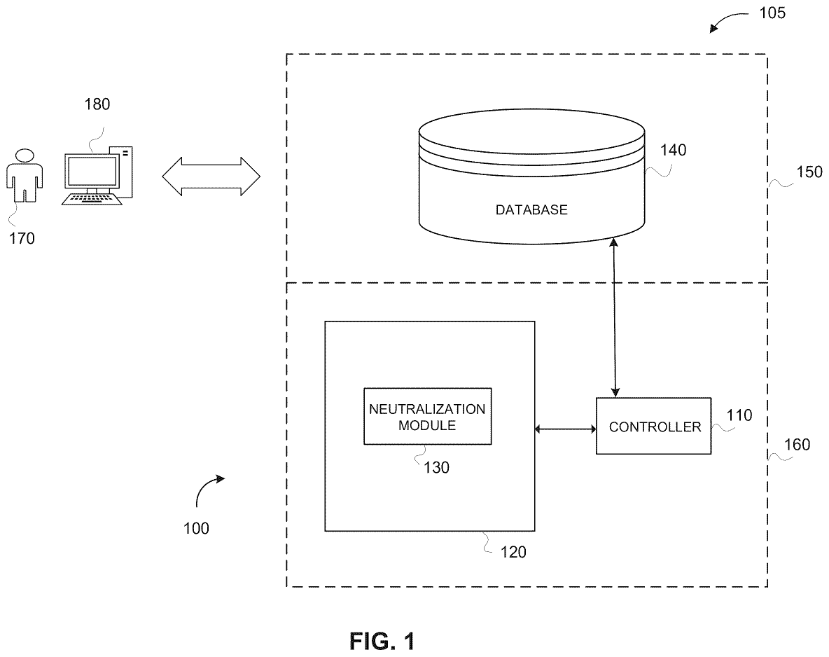

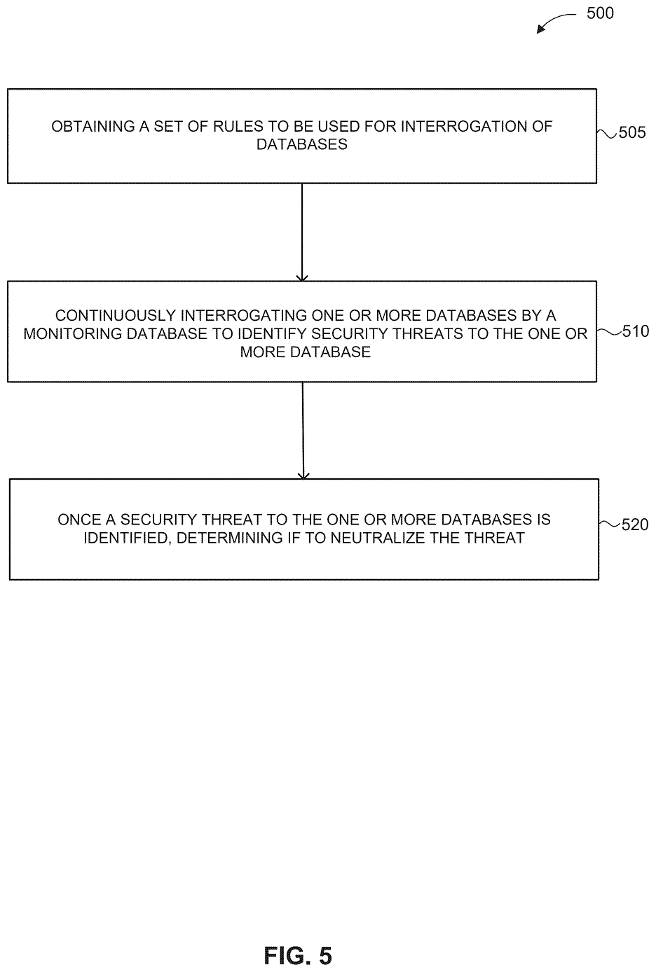

Reference is now made to FIG. 1, which is a diagram of a system 100 for protecting a database 140 according to the present disclosure. System 100 may include a controller 110 and a computer readable storage device or medium 120 (referred to herein as “storage device 120”). Storage device 120 may include a neutralization module 160. Neutralization module 160 may include instructions, which when executed by controller 110, may cause system 100 to neutralize an identified malicious activity performed with respect to database 140 while occurring. Database 140 may include a data masking mechanism. System 100 may utilize the data masking mechanism of system 140 to neutralize malicious activity applied to or performed with respect to database 140. System 100 may be configured to be deployed in various environments (development, staging, or production), including cloud and on-premises configurations. Neutralizing the malicious activity by system 100 may be performed by the disclosed methods, including method 200 of FIG. 2 and method 500 of FIG. 5, as will be detailed herein below.

Controller 110 may be coupled with database 140. According to some aspects, controller 110 may be or may include one or more controllers. According to some aspects, storage device 120 may be or may include one or more storage devices. According to some aspects, storage device 120 may be or may include a database, e.g., a monitoring database configured to monitor the customer's one or more databases such as database 140. According to some aspects, system 100 may include a monitoring database or may be a monitoring database coupled with controller 110.

According to some aspects database 140 and system 100 may be installed on a server 105. According to some aspects, server 105 may be or may include one or more servers or may be a server farm. According to some aspects, server 105 is a single server including database 140 and system 100. According to some aspects server 105 includes a server 150 and an additional separate monitoring server 160. Database 140 may then be installed on server 150 and system 100 or at least a portion of it may be installed on or included in monitoring server 160. The neutralizing of identified malicious activity performed by system 100 with respect to database 140 installed on server 150 is then operated via monitoring server 160 which is different from or a server separate from server 150. Such a setup may allow separation between resources required for operating database 140 and resources required for neutralizing malicious activities.

System 100 or controller 110 may be in communication with database 140. Execution of client SQL statements generated or sent to database 140 via an SQL client operated by, e.g., an end user 170 via a computing platform 180, may be intercepted to identify malicious activity. Computing platform 180 may be, for example, a personal computer, as shown in FIG. 1 or a server. According to some aspects, client SQL statements may be intercepted by system 100.

Databases 140 may include data owned, kept or managed by a customer or a user of system 100 such as an enterprise, a government organization, Small and Midsize Businesses (SMBs) with database assets, financial institutions, healthcare organizations, E-commerce platforms or any other entity interested in keeping the data protected from unauthorized access or cyber threats. System 100 may be deployed on or using the infrastructure of the customer (e.g., server 105, server 160, controller 110 or storage device 120) and may be managed by the customer once deployed and connected to the customer's environment, which may be, for example, deployed on-premises, via a private cloud, public cloud or semi-public cloud.

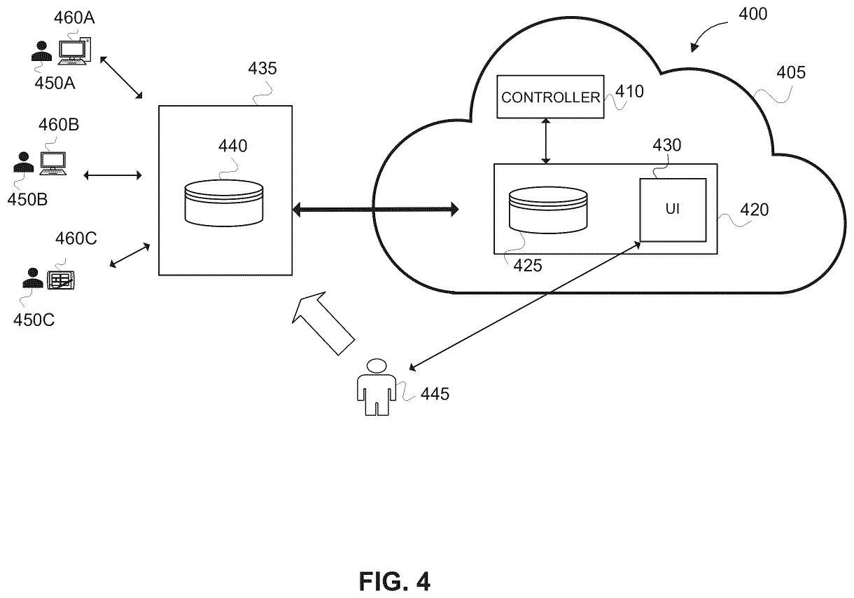

A computer implemented method for protecting a database is further disclosed. The method may be applied by the disclosed systems, such as system 100 of FIG. 1 or system 400 of FIG. 4 and as exemplified below. The method includes neutralizing an identified malicious activity performed with respect to the database, e.g., database 140, and during the occurrence of the malicious activity. The neutralizing of the malicious activity may utilize the data masking mechanism of the database. By utilizing the data masking mechanism of the database, neutralizing of malicious activities may be performed without affecting the database itself and without degrading the resources available for end-users other than the attacker. According to some aspects, the database (e.g., database 140) is installed on a server (e.g., server 150) and the neutralizing of identified malicious activities is operated via a monitoring server different than the server on which the database is installed (e.g., server 160).

The malicious activity may be generated by an SQL client, such as an SQL client running on computing platform 180 of end user 170 of FIG. 1. The malicious activity may include or may be performed via an incoming connection running a client SQL statement. The method may include altering the structure of the client SQL statement. According to some aspects, altering the structure of the client SQL statement may include replacing the client SQL statement with a crafted SQL statement. According to some aspects, the method may further include crafting the SQL statement replacing the client SQL statement. According to some aspects, the crafted SQL statement may include a pre-defined or pre-determined SQL statement.

According to some aspects, the altering of the structure of the client SQL statement is performed such that its result would delay the operation of the SQL client. According to some aspects, altering the structure of the client SQL statement may then include utilizing a function configured to pause the operation of the client SQL statement, e.g., by keeping the transaction open with a long wait time such as a ‘while’ endless loop. It may be performed, for example, by replacing the original SQL statement with a crafted query that takes a long time to execute, thereby delaying the SQL client's operation, or by locking the SQL client, thereby creating resource contention preventing the SQL client from progressing normally. For example, query blocking may be simulated by running a transaction that holds a lock on a resource and prevents other queries from completing. Delay of query execution and unresponsiveness simulation may be achieved by using the WAITFOR command.

According to some aspects, the altering of the structure of the SQL statement may be performed such that its result would hold significant memory of the SQL client. The SQL statement may be replaced with a crafted query designed to hold significant client memory and which eventually may not provide any data. This creates memory-intensive operations, consuming the client's resources and potentially causing performance degradation or application crashes. For example, the client SQL statement may be replaced by a crafted query designed to access data different from the data requested by the client SQL statement (e.g., the original SQL statement) which requires a very long data retrieval process or a very long data return process. Recovery from such memory-intensive operations may require the restarting of the computing platform from which the malicious activity originated (e.g., computing platform 180). This may gravely discourage or demotivate the attacker (e.g., end user 170) from keeping or from continuing the malicious activity against the database (e.g., database 140).

According to some aspects, the altering of the structure of the client SQL statement is performed in a dynamic manner. Accordingly, the alteration may be performed in a different manner for different client SQL statements. Altering the structure of the client SQL statement may be performed with respect to the client SQL statement and such that the result of the altered SQL statement is related to the client SQL statement. For example, although the data accessed by the crafted or replaced SQL statement would be different from the data requested by the client SQL statement, the crafted SQL statement may refer to data tables having the same label or name as the ones in the client SQL statement. Crafting the replacing SQL statement in a dynamic manner so that it would correspond to the client SQL statement (the original SQL statement), may promote or strengthen the attacker deterrence from reattacking or from continuing the malicious activity. Receiving a response that appears to be related to the attacker's client SQL statement may cause the attacker to be more reluctant to try attacking again as opposed to receiving a response that appears to be unrelated to the attacker's client SQL statement. For example, receiving a response that appears to be unrelated to the attacker's client SQL statement may cause the attacker to believe that there may be a specific, one-time error, and therefore the attacker may be less reluctant to try attacking again.

According to some aspects, the altering of the structure of the client SQL statement is performed via the data masking mechanism of the database to be protected (e.g., database 140). According to some aspects, altering the client SQL statement may include applying the data masking mechanism of the database on the client SQL statement and executing a crafted function via the data masking mechanism. According to some aspects, the crafted function may be configured to generate data, e.g., other than the requested data. According to some aspects, the data generation is performed in a manner corresponding to the client SQL statement, e.g., generating data under the same fields requested by the client SQL statement. For example, the data masking mechanism may execute a crafted function which recursively goes over all the fields of at least a portion of the database with no data retrieval. Execution of such a function may require a very long time and consume a great amount of resources per time.

According to some aspects, the method may further include the identification of the malicious activity. According to some aspects, the identifying of the malicious activity may include identification of an incoming SQL connection, e.g., to detect an unauthorized connection, and identification of the client SQL statement currently run by the incoming SQL connection, e.g., when the connection is allowed but the attempted actions or transactions are not (e.g., unauthorized access to data or SQL injection). According to some aspects, identifying the incoming SQL connection may include capturing the source Internet Protocol (IP) address of the incoming SQL connection which is running a client SQL statement at the very moment. The identification may include, for example, identifying the incoming connection as an allowed connection or as a forbidden or unauthorized connection, e.g., according to a predefined set of rules. According to some aspects, identifying the client SQL statement sent may include logging and analyzing the client SQL query sent by the SQL client. Alternatively, the identification of malicious activities may be provided, e.g., by the customer's computing infrastructure.

According to some aspects, the identification of the malicious activity may be performed according to techniques known to a person skilled in the art. According to some aspect, the identification of malicious activity may be performed according to the disclosed methods, such as method 500 of FIG. 5.

Reference is now made to FIG. 2, which is a flow diagram of a computer implemented method 200 for protecting databases, such as databases 140 of FIG. 1 or databases 440 of FIG. 4, from security threats or malicious activities, according to the disclosure. Method 200 may be applied by the disclosed systems, such as system 100 of FIG. 1 or system 400 of FIG. 4 and as exemplified below.

At an optional step 210 or prior to step 210, each incoming connection and its related client SQL statements to be applied to the database are monitored to identify malicious activity. End users such as end user 170 may operate an SQL client application on their computing platforms such as computing platform 180 of end user 170 to access databases such as database 140. Each such access initiates with an incoming connection which is used to run SQL statements on the accessed database. All such incoming connections and their run SQL statements are monitored to identify malicious activities. The monitoring may be performed, for example, by intercepting such client SQL statements by system 100. Storage device 120 may further include instructions for performing such monitoring to be executed by controller 110. As indicated herein above, such monitoring or identifying of malicious activity is optional according to the disclosure. According to some aspects, identified malicious activity may be provided or indicated, e.g., via the customer's computing infrastructure.

At a step 220, once a malicious activity is identified, it is determined if the identified malicious activity or attack should be neutralized. In general, one or more countermeasures may be applied, once a malicious activity is identified. The one or more countermeasures may include, for example, reporting the identified security threat, masking data, closing the attacker's connection or neutralizing the attack. According to some aspects, the method may further include selecting the appropriate one or more countermeasures to be applied for each identified malicious activity (if at all), or when to apply such countermeasures. The selection may be performed according to a set of rules or logic, e.g., defined based on the customer's requirements. Different malicious activities or different stages of the malicious activity at which the malicious activity is identified may require the application of different countermeasures. According to some aspects, such selection may be provided, e.g., via the customer's computing infrastructure.

At an optional step 230, if neutralizing of the attack is selected as a counteraction or countermeasure to be applied against an identified malicious activity, an SQL statement may be dynamically crafted based on the client SQL statement. The crafted SQL statement may be crafted to provide results resembling the results requested by the client SQL statement.

At a step 240, the client SQL statement is replaced such that its result would delay the operation of the SQL client or would hold significant memory of the SQL client. The client SQL statement may be replaced with a crafted SQL statement which may be, for example, a predefined statement, a fixed statement used for each identified malicious activity or the dynamically crafted SQL statement of step 230.

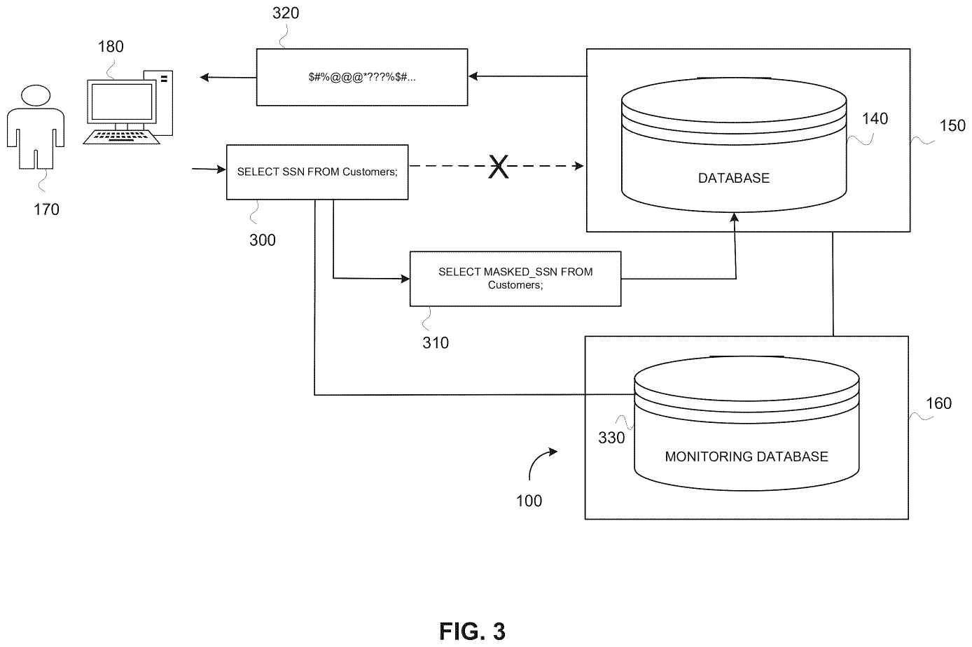

Reference is now made to FIG. 3, which is an illustration of an exemplary neutralization process of a malicious activity against database 140 by system 100 of FIG. 1. At a first stage, a hacker, end user 170, submits a query 300 to database 140, which is installed on server 150, attempting to extract sensitive information: “SELECT SSN FROM Customers”. At a second stage, system 100, which in this Figure includes a monitoring database 330 and is installed on a different monitoring server 160, intercepts query 300 before it reaches database 140, e.g., by recognizing that query 300 includes sensitive columns (e.g., Social Security Number (SSN)). At a third stage, a dynamic masking is applied to the sensitive fields of the requested data by system 100, e.g., by transforming the hacker query 300 to query 310: “SELECT MASKED_SSN FROM Customers”. At a fourth stage, database 140 executes the modified or altered query 310 and returns safe, masked results including an exponential number of records of masked data 320. At a fifth stage, the hacker receives the excessive masked data 320, while data leakage is prevented and system integrity is maintained. Excessive masked data or results 320 may consume the computing resources of computing platform 180 of hacker 170 which may lead, for example, to crashing of the client SQL application run by computing platform 180. Hacker 170 may then be demotivated or become reluctant to reinitiate or continue the attack against database 140.

Reference is now made to FIG. 4, which is a diagram of a further system 400 for protecting databases. System 400 is aimed at identifying, protecting and neutralising malicious activities or cybersecurity threats against databases, e.g., of a customer. System 400 may allow the identification of malicious activities and the protection of databases therefrom in a remote or agentless manner, without “stepping into” the servers to be protected.

System 400 may include a controller 410 and a monitoring server 420. Monitoring server 420 may include a monitoring database 425 and optionally a dedicated UI 430. According to some aspects, controller 410 may include one or more controllers. According to some aspects, controller 410 may be included in monitoring server 420 or at least one controller of controller 410. According to some aspects, system 400 may apply the disclosed methods, such as method 200 of FIG. 2 or method 500 of FIG. 5, as detailed hereinbelow.

System 400 may be in communication with one or more servers 435 including one or more databases 440. Each server of servers 435 may include one or more databases of databases 440. Monitoring server 420 is a different or a separate server from servers 435, at least logically. Monitoring server 420 may be configured to remotely connect to servers 435. According to some aspects, database 425 may be configured to generate SQL queries for interrogating databases 440, e.g., via a dedicated engine, to identify malicious activities against databases 440. According to some aspects, server 420 and database 425 may not receive, store or include the data of the customer or the data to be protected, such as the data of databases 440. According to some aspects, server 420 and database 425 may receive, store or include metrics information or data relating to databases 440 and servers 435.

According to some aspects, servers 435 and databases 440 may be accessed by authorized end users such as end users 450A-450C via computerized devices such as Personal Computer (PC) 460A, terminal 460B or a tablet 460C, respectively. Servers 435 and databases 440 may include data owned, kept or managed by a customer or a user of system 400 interested in keeping the data protected from unauthorized access or cyber threats. System 400 may be deployed on or using the infrastructure of the customer (e.g., on-premises, private cloud, public cloud or semi-public cloud) and may be managed by the customer once deployed and connected to the customer's environment (e.g., servers 435). System 400 may be configured to be deployed in various environments (development, staging, or production), including cloud, such as cloud 405, and on-premises configurations. According to some aspects, servers 440 and monitoring server 420 may be deployed on the same infrastructure or platform owned or managed by the customer, such as cloud 405 or a server farm.

According to some aspects, system 400 may provide a dedicated UI 430 which may issue or output alerts, reports and allow setting the operation of system 400. Additionally, or alternatively, system 400 may connect with applications of the customer including various user-facing applications (e.g., web portals, mobile apps) that may access system 400 for data retrieval and storage.

A user 445 may act for the customer and may be, for example, a Development Operations (DevOps) professional or a Data Base Administrator (DBA), e.g., administrating databases 440. User 445 may interact with, or manage the operation of system 400, e.g., via UI 430.

According to some aspects, system 400 may connect with various external entities, including client applications, external databases and data sources which may include databases other than databases 440 or third-party data providers that may feed data into system 400 or receive data from it, authentication and authorization systems such as identity management systems (e.g., Lightweight Directory Access Protocol, Single Sign-On, Multi-Factor Authentication solutions) for secure access control, and monitoring and logging services such as real-time monitoring tools and logging systems that track the performance and usage of system 400 for auditing and maintenance purposes.

Reference is now made to FIG. 5, which shows a flow diagram of a further computer implemented method 500 for protecting one or more databases, such as databases 440 of FIG. 4 or database 140 of FIG. 1, installed on one or more respective servers, such as servers 435 of FIG. 4 or server 160 or 105 of FIG. 1, from security threats or malicious activities. Method 500 may be applied by the disclosed systems, such as system 100 of FIG. 1 or system 400 of FIG. 2, mutatis mutandis.

At a step 510, the one or more databases may be interrogated by a monitoring database to identify security threats to the databases. The one or more databases may be installed on a monitoring server. The monitoring server is different from or separate from the one or more servers on which the interrogated or protected databases are installed. According to some aspects, the interrogation is performed in an agentless manner. With reference to FIG. 4, one or more databases 440, which are installed on one or more servers 435, may be interrogated by monitoring database 425. Monitoring database 425 is installed on monitoring server 420 and is different from servers 435. One or more databases 440 are interrogated by monitoring database 425 to identify security threats, e.g., malicious activities, to one or more databases 440, such as unauthorized access of an end-user such as end-users 450A-C to one or more databases 440. According to some aspects, the monitoring server may be installed on the premises of the owner or the keeper of the one or more databases (e.g., the customer). According to some aspects, the monitoring server is installed on a cloud as a Software as a Service (SaaS).

According to some aspects, the interrogation of the one or more databases is performed by the monitoring server remotely connecting to the one or more servers, respectively. Referring to FIG. 4, server 420 may remotely connect to one or more servers 435 to allow the interrogation of one or more databases 440 by monitoring database 425.

According to some aspects, the interrogation is performed by sending SQL queries issued by the monitoring database (e.g., database 425) to the one or more databases (e.g., one or more databases 440). The interrogation allows the collection of information of interest from target databases. According to some aspects, the interrogation may be continuously performed, e.g., once in a defined time interval and in a rapid manner.

An interaction with a database may include a plurality of operations or stages, including a connection, a session and a transaction. One or more or all of these stages may be interrogated via queries. According to some aspects, one or more or all of servers 435 and one or more or all of databases 440 may be automatically interrogated. However, this may be set for or by each specific customer according to the customer's needs.

According to some aspects, the interrogation includes the monitoring server (e.g., server 420) running queries on remote servers (e.g., servers 435) to collect data and storing the returned data into respective tables. The tables may be stored, for example, on the monitoring server. According to some aspects, each query is or represents a metric. A metric may be, for example, a query asking for the active connections or a query asking for the number of reads at a certain time of a certain database by an end-user. The returned data for each query may be then the result of the metric. According to some aspects, each metric may be assigned with at least one threshold. Once a metric result is received (e.g., in response to a query), it is determined if the result is within or exceeds the assigned one or more thresholds.

According to some aspects, the one or more thresholds assigned to each metric may be set in a dynamic manner. The one or more thresholds may be continuously recalculated or continuously or dynamically determined, e.g., once per a predefined time interval. The thresholds may be dynamically determined, e.g., for each metric, for each customer or for each interrogated server. An optimal value may be dynamically determined for the thresholds based on predefined criteria, often used in anomaly detection, classification, or decision-making. The dynamic thresholds may be determined, e.g., based on the trends of the interrogated server. According to some aspects, the dynamic thresholds may be determined via a threshold configurator algorithm, e.g., based on AI, machine-learning or deep learning techniques. The dynamic thresholds may be determined, e.g., based on the calculation of a moving average.

At a step 520, once a security threat to a database of the one or more databases is identified, it is determined if to neutralize the attack, or, e.g., apply one or more other countermeasures. The one or more other countermeasures may include at least one of reporting the identified security threat, masking data of the database or closing the attacker's connection. Reporting the identified security threat may include sending a notification mail to the user or the customer, e.g., to user 445. Additionally or alternatively, an alert may appear on the screen of the user UI such as UI 430 or a respective report may be issued. Masking data of the database at risk may include masking all of the data of the database or a portion of the data which is identified as being at risk, e.g., data stored in an area of the database to which an unauthorized user is trying to access. Neutralizing the attack may be performed according to the disclosed methods including method 200 of FIG. 2. If it is determined that the identified security threat would be neutralized, then method 500 may further include the step of neutralizing the identified security threat as disclosed, e.g., according to method 200 of FIG. 2.

According to some aspects, the interrogation of the one or more databases or the application of the one or more countermeasures may be performed according to or based on a set of rules. One or more rules of the set of rules may be based on one or more metrics. The set of rules may be implemented via or based on various techniques as known to a person skilled in the art. According to some aspects, the set of rules is, includes or is implemented as one or more decision trees.

A computer program product including a computer-readable storage medium having computer-executable instructions for neutralizing an identified malicious activity performed with respect to a database while occurring is further disclosed. The computer program product may be or may include one or more storage devices such as storage device 120 of system 100 of FIG. 1 or a storage device of system 400 of FIG. 4. According to some aspects, the computer-executable instructions may be configured to trigger or cause the performance of the disclosed methods, including method 200 of FIG. 2 or method 500 of FIG. 5.

The computerized systems disclosed herein, such as system 100 of FIG. 1 or system 400 of FIG. 4 may include a processor or controller (e.g., controller 110 or 410, respectively) that may be or include, for example, one or more central processing unit processor(s) (CPU), one or more Graphics Processing Unit(s) (GPU or GPGPU), and/or other types of processor, such as a microprocessor, digital signal processor, microcontroller, programmable logic device (PLD), field programmable gate array (FPGA), or any suitable computing or computational device. The computerized systems may also include a memory, a storage (e.g., storage device 120 of system 100), a communication device or an operating system.

The operating system may be or may include any code designed and/or configured to perform tasks involving coordination, scheduling, arbitration, supervising, controlling or otherwise managing the operation of the disclosed computerized system. The memory may be or may include, for example, one or more Random Access Memory (RAM), read-only memory (ROM), flash memory, volatile memory, non-volatile memory, cache memory, and/or other memory devices. The memory may store, for example, executable instructions that carry out an operation (e.g., executable code) and/or data. Executable code may be any executable code, e.g., an app/application, a program, a process, task or script. Executable code may be executed by the controller such as controller 110 of system 100 or controller 410 of system 400.

The storage (e.g., storage device or medium 120 of system 100) may be or may include, for example, one or more of a hard disk drive, a solid state drive, an optical disc drive (such as DVD or Blu-Ray), a USB drive or other removable storage device, and/or other types of storage devices. Data such as instructions, code, procedure data, among other things, may be stored in the storage and may be loaded from the storage into the memory where it may be processed by the controller (e.g., controller 110 or 410).

The illustrated components of FIGS. 1, 3 and 4 are exemplary and variations are contemplated to be within the scope of the present disclosure. For example, the numbers of components may be greater or fewer than as described and the types of components may be different than as described. When the disclosed systems implement a data storage system, a large number of storages may be utilized. As another example, when the disclosed systems implement a server system, a large number of central processing units or cores may be utilized. Other variations and applications are contemplated to be within the scope of the present disclosure.

Unless specifically stated otherwise, as apparent from the preceding discussions, it is appreciated that throughout the specification discussions utilizing terms such as “processing”, “computing”, “storing”, “determining”, “causing” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. Furthermore, unless stated otherwise, the term “causing” may also include triggering, e.g., triggering one or more action and/or processes of a computer or computing system or similar electronic computing device, which may cause the indicated result.

Different aspects are disclosed herein. Features of certain aspects can be combined with features of other aspects; thus, certain aspects can be combinations of features of multiple aspects.

While several embodiments of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A computer implemented method for protecting a database, the method comprising neutralizing an identified malicious activity performed with respect to the database while occurring.

2. The method according to claim 1, wherein the database comprises a data masking mechanism and wherein neutralizing the malicious activity utilizes the data masking mechanism.

3. The method according to claim 1, wherein the malicious activity is generated by a Structured Query Language (SQL) client and comprises an incoming connection currently running a client SQL statement, and wherein the method further comprises altering the structure of the client SQL statement.

4. The method according to claim 3, wherein altering the structure of the client SQL statement comprises replacing the client SQL statement with a crafted SQL statement.

5. The method according to claim 3, wherein the altering of the structure of the client SQL statement is performed such that its result would delay the operation of the SQL client.

6. The method according to claim 5, wherein altering the structure of the client SQL statement comprises utilizing a function configured to pause the operation of the client SQL statement.

7. The method according to claim 3, wherein the altering of the structure of the SQL statement is performed such that its result would hold significant memory of the SQL client.

8. The method according to claim 3, wherein the altering of the structure of the client SQL statement is performed in a dynamic manner.

9. The method according to claim 3, wherein the altering of the structure of the client SQL statement is performed with respect to the client SQL statement and such that the result of the altered SQL statement is related to the client SQL statement.

10. The method according to claim 3, wherein the database comprises a data masking mechanism and wherein the altering of the structure of the client SQL statement is performed via the data masking mechanism.

11. The method according to claim 3, wherein altering the client SQL statement comprises:
applying a data masking mechanism of the database on the client SQL statement; and
executing a crafted function via the data masking mechanism, the crafted function configured to generate data.

12. The method according to claim 1, further comprising identifying the malicious activity.

13. The method according to claim 1, wherein the database is installed on a server, and wherein the neutralizing of the identified malicious activity performed with respect to the database is operated via a monitoring server different from the server.

14. A system for protecting a database, the system comprising:
at least one controller; and
at least one computer readable storage device storing instructions for execution by the at least one controller, the instructions, when executed, cause the system to neutralize an identified malicious activity performed with respect to the database while occurring, wherein the database comprises a data masking mechanism and wherein neutralizing of the malicious activity utilizes the data masking mechanism.

15. The system according to claim 14, wherein the malicious activity is generated by a Structured Query Language (SQL) client and comprises an incoming connection currently running a client SQL statement, and wherein the instructions, when executed, further cause the system to alter the structure of the client SQL statement by replacing the client SQL statement with a crafted SQL statement.

16. The system according to claim 15, wherein the altering of the structure of the client SQL statement is performed such that its result would delay the operation of the SQL client.

17. The system according to claim 15, wherein the altering of the structure of the SQL statement is performed such that its result would hold significant memory of the SQL client.

18. The system according to claim 15, wherein the altering of the structure of the client SQL statement is performed with respect to the client SQL statement and such that the result of the altered SQL statement is related to the client SQL statement.

19. The system according to claim 14, wherein the database is installed on a server, and wherein the neutralizing of the identified malicious activity performed with respect to the database is operated via a monitoring server different from the server.

20. A computer program product comprising a computer-readable storage medium having computer-executable instructions for causing the neutralization of an identified malicious activity performed with respect to a database while occurring.

21. The computer program product according to claim 20, wherein the database comprises a data masking mechanism and wherein neutralizing the malicious activity utilizes the data masking mechanism.

22. The computer program product according to claim 20, wherein the malicious activity is generated by a Structured Query Language (SQL) client and comprises an incoming connection currently running a client SQL statement, and wherein the instructions are configured to cause the alteration of the structure of the client SQL statement by replacing the client SQL statement with a crafted SQL statement.

23. The computer program product according to claim 22, wherein the altering of the structure of the client SQL statement is to be performed such that its result would delay the operation of the SQL client.

24. The computer program product according to claim 22, wherein the altering of the structure of the SQL statement is to be performed such that its result would hold significant memory of the SQL client.

25. The computer program product according to claim 22, wherein the altering of the structure of the client SQL statement is to be performed with respect to the client SQL statement and such that the result of the altered SQL statement is related to the client SQL statement.
